(19) United States
(12) Patent Application Publication
(10) Pub. No.: US 2005/0024518 A1
(43) Pub. Date: Feb. 3, 2005

(54) Lens adjusting mechanism

(76) Inventors: Kuo Wen Chang, Chung Ho City (TW); Nien Ting Weng, Chung Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/627,651

(22) Filed: Jul. 28, 2003

(51) Int. Cl. H04N 5/225; G02B 13/16

(52) U.S. Cl. 348/335

(57) ABSTRACT

The present invention provides a lens adjusting mechanism, which includes a first platform, a second platform, a mounting foot and a spiral lock member. A first assembling aperture is formed along the rim of the first platform. A second assembling aperture is formed along the rim of the second platform in accordance with the first assembling aperture of the first platform. The second platform is mounted above the first platform by passing the spiral lock member through the first assembling aperture and the second assembling apertures. The second platform has a flexibility portion adjacent to the second assembling aperture. A hinge groove is opened between the second assembling aperture and an end part of the flexibility portion, so that the flexibility portion is capable of flexing. The mounting foot supports on the first platform, and against the end part of the flexibility portion. When screwing the spiral lock member, the second platform achieve a specific inclination through a pull acted by the spiral lock member and a push acted by the flexibility portion, thus, the lens positioned on the second platform can be accordingly adjusted via the specific inclination.

### BACKGROUND OF THE INVENTION

1. Field of the Invention

The present invention relates to a lens adjusting mechanism which adjusts a perpendicularity of a lens optical axis to a image sensor surface at a center of the image sensor, and more particularly, to a mechanism for adjusting lens which simplifies adjusting process and reducing parts of the mechanism.

2. The Related Art

Generally, an optical imaging product commonly comprises lens group, image sensor and so on. During products manipulated, such as a digital still camera in order to obtaining a clear image, it is very important to insure an axis of lens group vertically aligned with a center of the image detected area (IDA) of the image sensor.

Till now, it is very difficult to insure the optical axis of lens group vertically to IDA and precisely aligned with the normal line of IDA through the center of IDA in a course of producing digital cameras. For example, a factory producing digital cameras commonly will not manufacture all assemblies. The image sensor such as CCD or CMOS will be packaged and tested in s package factory after it was made in semiconductor foundry. However, finally integrating manufacturers find that, under a commonly manufacturing process, the axis of the lens group is not vertically to IDA and precisely aligned with the normal line through the center of IDA, and a chip's location is not fixed exactly in a course of package housing.

Because the location error can't be corrected after sensors packaged, at present, a mechanism for correcting the location error is to adjust the lens. Please refer to FIGS. 7, 8 and 9. The mechanism shown in FIG. 7 illustrates a method to adjust the lens by a pair of screws. It is necessary to adjust two screws at the same time. The operation of adjustment is very difficult. FIGS. 8 and 9 show another embodiment to adjust the lens, which adjusts a screw and urges a spring. The adjustment is not precise. Such method is not convenience, and increases additional spring members.

### SUMMARY OF THE INVENTION

Thus, an object of the present invention is to provide a lens adjusting mechanism for adjusting a perpendicularity of the lens optical axis to IDA at the center of IDA, simplifying the adjusting process, and reducing number of parts of the mechanism.

To attain the above object, the present invention provides a lens adjusting mechanism, which includes a first platform, a second platform, a mounting foot and a spiral lock member. A first assembling aperture is formed along the rim of the first platform. A second assembling aperture is formed along the rim of the second platform in accordance with the first assembling aperture of the first platform. The second platform is mounted above the first platform by passing the spiral lock member through the first assembling aperture and the second assembling apertures. The second platform has a flexibility portion adjacent to the second assembling aperture. A hinge groove is opened between the second assembling aperture and an end part of the flexibility portion, so that the flexibility portion is capable of flexing. The mounting foot supports on the first platform, and against the end part of the flexibility portion.

When screwing the spiral lock member, the second platform achieves a specific inclination through a pull acted by the spiral lock member and a push acted by the flexibility portion. Thus, the lens positioned on the second platform can be accordingly adjusted via the specific inclination, and a perpendicularity of a lens optical axis to an image sensor surface at a center of the image sensor can be assured.

### BRIEF DESCRIPTION OF THE DRAWINGS

A detailed explanation of a preferred mode of the present invention will be given, with reference to the attached drawings, for better understanding thereof to those skilled in the drawings:

FIG. 1 is a perspective view of a lens adjusting mechanism in accordance with the first embodiment of the present invention;

FIG. 2 is a perspective view of the lens adjusting mechanism in accordance with the second embodiment of the present invention;

FIG. 3 is a perspective view of the for lens adjusting mechanism in accordance with the third embodiment of the present invention;

FIG. 4 is a partial sectional view of the for lens adjusting mechanism to show an engagement of a spiral lock member with a first and second platform therebetween in according to the present invention;

FIG. 5 is a sectional view of the for lens adjusting mechanism of FIG. 1 to describe a non-adjusting state of the for adjusting lens mechanism;

FIG. 6 is a sectional view of the for lens adjusting mechanism of FIG. 1 to describe an adjusting state of the for adjusting lens mechanism;

FIG. 7 is a sectional view of a conventional mechanism;

FIG. 8 is a sectional view of another conventional mechanism; and

FIG. 9 is a sectional view of a further conventional mechanism;

### DETAILED DESCRIPTION OF THE BEST MODE FOR CARRYING OUT THE PRESENT INVENTION

An overview of an imaging process of optical imaging products will be given first before the present invention is explained in detail. Image light of a subject is directed toward a lens of the optical imaging product from a subject firstly, then the lens focuses the image light on a optics and image sensor member. The optics and image sensor member comprises an image sensor at least. Once the image sensor of the optics and image sensor member is exploded to the image light, a final image can be generated in accordance with the subject.

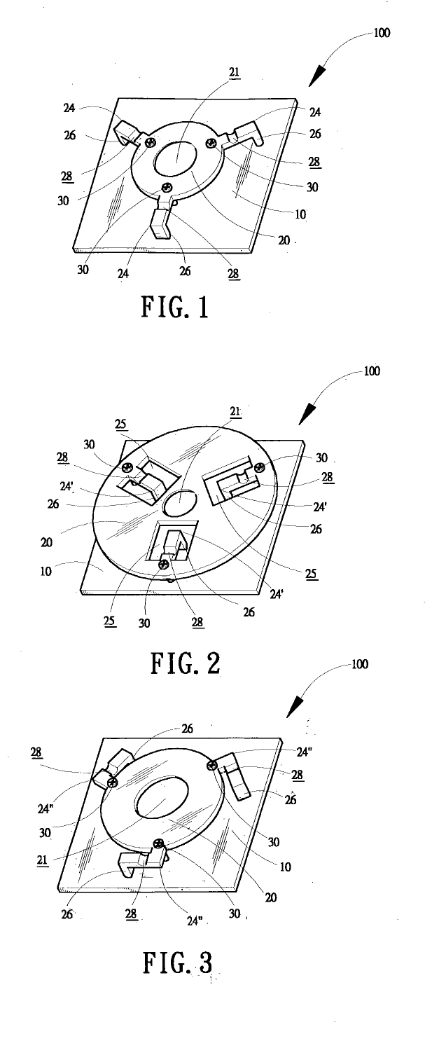

As shown in FIGS. 1 to 4, a lens adjusting mechanism, in accordance with the present invention, generally designed with reference numeral 100. The lens adjusting mechanism comprises a first platform 10 with a rectangular configuration, a second platform 20 with a round configuration and a plurality of spiral lock members 30, such as bolts, to engage with the first platform 10 and the second platform 20.

The first and the second platforms 10,20 mount the optics and image sensor member and the lens therein respectively. In order to direct the imagine light to the optics and image sensor member from the lens, an aperture 21 is formed in the central section of the second platforms 20 therein. The second platform 20 is mounted above the first platform 10 by passing spiral lock members 30 through a plurality of first and second assembling apertures 12,22 of the first platform 10 and the second platform 20 to interlock the first platform 10 and the second platform 20. The first assembling apertures 12 are formed along a rim of the first platform 10, the second assembling apertures 22 are formed along a rim of the second platform 20 in accordance with the first assembling apertures 12. In the first, the second and the third embodiments illustrated, there are three first and second assembling apertures, which a center point thereof is located on a periphery and a circumferential angle between two adjacent first or second apertures 12,22 is 120 degree.

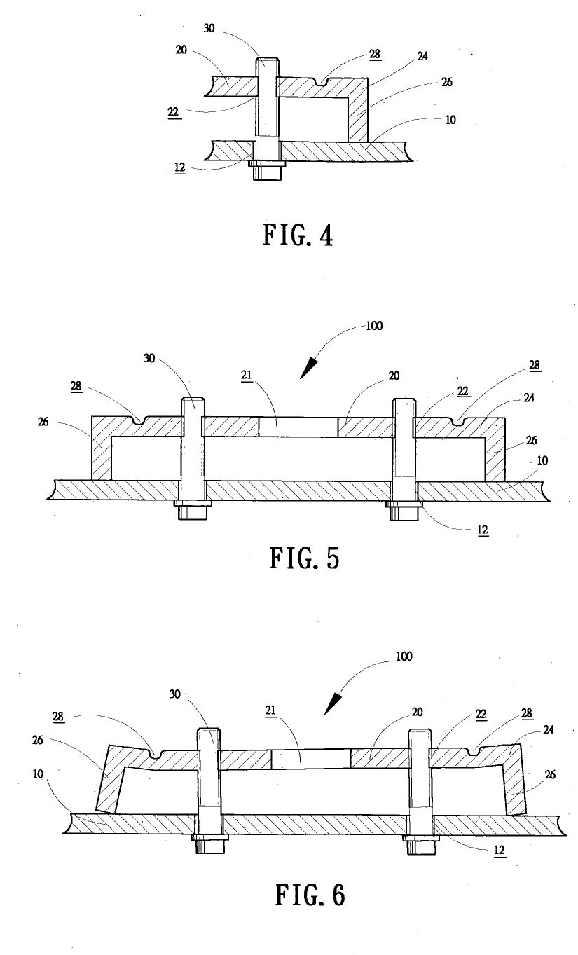

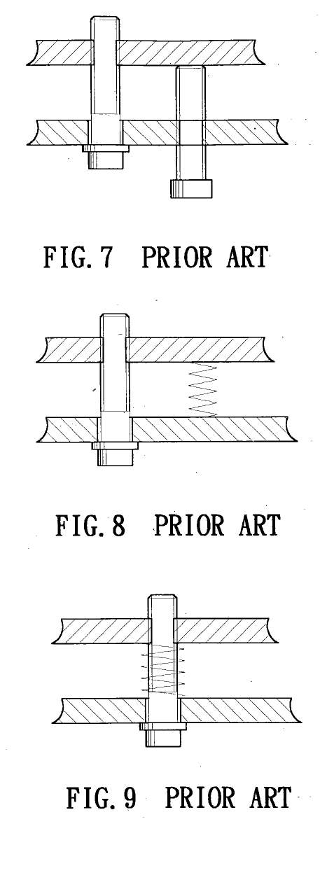

Referring to the FIGS. 1 to 4 and in particular to FIG. 4, the second platform 20 has a plurality of flexibility portions 24 adjacent to the second assembling apertures 22. A hinge groove 28 is opened between each of the second assembling apertures 22 and an end part of each flexibility portions 24. So that the flexibility portions 24 are capable of flexing and provides a push acted on the second platform 20 via a flexibility deformation of the hinge groove 28 while screwing spiral lock members 30 to act a pull on the second platform 20. Thereby, the screw or spring utilized in the prior art can be substituted by the flexibility portion 24. A plurality of mounting feet 26 arrange between the first and second platform 10, 20 supporting on the first platform 10 and against the end part of flexibility portions 24. As fabricating, the mounting feet 26 can assemble with the first platform 10 (not shown) or the second platform 20 (as shown in FIGS. 1 to 4), and also can form individually (not shown), in addition, the hinge groove 28 can be formed on a top surface of the second platform 20 (as shown in FIGS. 1 to 4) or a bottom surface of the second platform 20 (not shown).

With reference to FIGS. 1 to 3 again, in the lens adjusting mechanism 100 of each embodiment of the present invention described, a difference design thereof is a position of the flexibility portions 24. As shown in FIG. 1, the flexibility portions 24 extend outwardly from the second platform 20 along a radial direction. As shown in FIG. 2, the second platform 20 is shaped in its inter portion with three U-shaped grooves 25 to form the flexibility portions 24′ which extend toward a center of a circle of the second platform 20 along a radial direction. Moreover, the hinge grooves 28 are opened on the upper surface of the flexibility portions 24′ and positioned between the spiral lock members 30 and the mounting feet 26. As described in FIG. 3, the flexibility portions 24″ arrange along a tangent direction on the rim of the second platform 20 and the hinge grooves 28 are still opened on the upper surface of the flexibility portions 24″ and positioned between the spiral lock members 30 and the mounting feet 26.

Referring now to FIGS. 5 and 6, different adjustment states for mechanism for adjusting lens 100 of the present invention are described. As each embodiment has the same adjustment principle, only the first embodiment is illustrated in the drawings. As shown in FIG. 6, side portions of the flexibility portions 24 on both sides of the hinge grooves 28 can be regarded as rigid bodies. If maintaining the first platform 10 and random two spiral lock members 30 fixing and screwing the third spiral lock member 30, the second platform 20 will move downwardly by means of a pull generated by the third screwing spiral lock member 30. Simultaneously, the third hinge groove 28 in accordance with the third spiral lock member 30 will flex downwardly because of its flexibility. The side portions of the flexibility portions 24 on both sides of the hinge grooves 28 will move upwardly on account of the mounting feet 26 and the spiral lock member 30 mounting the second platform 20, thereby the second platform 20 is acted a pull thereof. Consequently, the second platform 20 and the lens mounting therein can be adjusted through a combination of the pull and the push described above, and a perpendicularity of a lens optical axis to a image sensor surface at a center of the image sensor can be assured.

In fact, the first and the second spiral lock members 30 can also generate a tiny displacement following with a movement of the third spiral lock member 30, thereby providing a tiny adjustment for the mechanism for adjusting lens 100.

As above description, the pull and the push can be achieved owing to arranging the hinge grooves 30 on the flexibility portion 24 of the second platform 20. Thus the lens adjusting mechanism 100 of the present invention omits the spring member, and provides a simply mechanism and a convenient manipulate.

On the adjustment process of the present invention, each configuration which is comprised of a mounting foot 26, a hinge groove 28 and a spiral lock member 30 corresponding each other, can provide an individual adjustment direction, and the final adjustment effect is attained by several configurations stacked.

Although a particular embodiment of the invention has been described in detail for purposes of illustration, additional advantages and modifications will readily appear to those skilled in the art, and various modifications and enhancements, such as mounting the lens on the first platform 10 and arranging the optic and image sensor portion in the second platform 20 accordingly, or assembling the spiral lock members 30 from the second assembling aperture 22 to the first assembling aperture 12, may be made without departing from the spirit and scope of the invention, so the invention is not to be limited except as by the appended claims.

1. A lens adjusting mechanism comprising:
a first platform, forming a first assembling aperture along a rim of the first platform;
a second platform, mounted above the first platform and forming a second assembling aperture along a rim of the second platform in accordance with the first assembling aperture of the first platform, the second platform having a flexibility portion adjacent to the second assembling aperture, a hinge groove opened between the second assembling aperture and an end part of the flexibility portion;
a mounting foot supported on the first platform, and against the end part of the flexibility portion; and
a spiral lock member, passing through the first assembling aperture of the first platform and the second assembling aperture of the second platform to interlock therebetween.

2. The lens adjusting mechanism claimed in claim 1, wherein the mounting foot is assembled with the first platform.

3. The lens adjusting mechanism claimed in claim 1, wherein the mounting foot is assembled with the second platform.

4. The lens adjusting mechanism as claimed in claim 1, wherein the hinge groove is formed on a top surface of the second platform.

5. The lens adjusting mechanism as claimed in claim 1, wherein the hinge groove is formed on a bottom surface of the second platform.

6. The lens adjusting mechanism as claimed in claim 1, wherein the flexibility portion extends outwardly from the second platform along a radial direction.

7. The lens adjusting mechanism as claimed in claim 1, wherein the second platform is shaped in its inter portion with a U-shaped groove to form the flexibility portion which extends toward a center of a circle of the second platform along a radial direction.

8. The lens adjusting mechanism as claimed in claim 1, wherein the flexibility portion arranges along a tangent direction on the rim of the second platform.

9. The lens adjusting mechanism as claimed in claim 1, wherein the first platform is utilized to mount the lens thereon.

10. The lens adjusting mechanism as claimed in claim 1, wherein the second platform is utilized to mount the lens thereon.
